(19) United States
(12) Patent Application Publication
(10) Pub. No.: US 2026/0237106 A1
(43) Pub. Date: Aug. 13, 2026

(54) VIRTUAL BACKGROUND DE-ACTIVATION DURING A VIDEO COMMUNICATION SESSION BY AN ELECTRONIC DEVICE

(71) Applicant: MOTOROLA MOBILITY LLC, WILMINGTON, DE (US)

(72) Inventors: RANJEET GUPTA, Aurora, IL (US); RAHUL BHARAT DESAI, Hoffman Estates, IL (US)

(21) Appl. No.: 19/053,373

(22) Filed: Feb. 13, 2025

(51) Int. Cl. G06T 11/00; G06V 20/20; G06V 20/40; G06V 40/16; H04L 12/18; H04L 65/1089; H04L 65/403

(52) U.S. Cl. CPC G06T 11/00; G06V 20/20; G06V 20/40; G06V 40/166; H04L 12/1822; H04L 65/1089; H04L 65/403; G06T 2200/24

(57) ABSTRACT

An electronic device, a method and a computer program product triggers de-activating of a virtual background of a live video feed during a video communication session in response to detecting a new face in a background of the participant captured by a camera. The method includes, while presenting to a video communication session, a live video feed comprising a foreground image that is superimposed onto a virtual background, monitoring background FOV of the camera to detect a presence/entry of a new face in the background FOV. In response to detecting the new face, the method includes determining if the new face is a face of an approved on-screen video conference (AOVC) individual. The method includes rendering and presenting a user selectable option on a display to de-activate the virtual background from the video feed, in response to the new face being of an AOVC individual.

### BACKGROUND

### 1. Technical Field

The present disclosure generally relates to electronic devices and in particular to electronic devices that enable a video communication session between electronic devices.

### 2. Description of the Related Art

Electronic devices, such as mobile phones, tablets, and laptops, are widely used for video, voice, and text communication and for data transmission. Many conventional electronic devices have at least one front facing camera and one or more rear facing cameras, along with one more display devices. Electronic devices with cameras can be used to conduct video conferences or video calls with one or more other electronic devices. During a video conference, a user can choose to turn on a virtual background that replaces the current video background with a pre-selected virtual background. A virtual background is an image or video that is imposed behind the user while they are in the video conference or video call.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices and several image capturing devices, according to one or more embodiments;

FIG. 1C is an example illustration of the front of an electronic device with a front display and multiple front cameras, according to one or more embodiments;

FIG. 1D is an example illustration of the rear of an electronic device with a rear display and multiple rear cameras, according to one or more embodiments;

FIG. 2 is an example block diagram of a video communication session environment, according to one or more embodiments;

FIG. 3 is a block diagram of example contents of the memory subsystem of the example electronic device of FIGS. 1A-1B (FIG. 1), which configures the electronic device to complete the various processes described herein, according to one or more embodiments;

FIG. 4 illustrates an example electronic device being used during a video communication session to capture live video of a local participant of the video communication session and including a virtual background, according to one or more embodiments;

FIG. 5A illustrates an example of a local participant in a video communication session, showing the respective field of view (FOV) of two cameras, capturing a background image, according to one or more embodiments;

FIG. 5B illustrates an example of a local participant in a video communication session after an individual has entered the background FOV during the video communication session, according to one or more embodiments;

FIG. 6A illustrates an example virtual background activation/de-activation graphical user interface presented on a display of an electronic device, according to one or more embodiments; and

FIG. 6B illustrates an example live video feed, without a virtual background, being presented on a display of an electronic device after the selection of a de-activate virtual background user-selectable option, according to one or more embodiments; and

FIG. 6C illustrates an example video communication session with a local participant and several other remote participants being presented on an external display, according to one or more embodiments;

FIGS. 7A-7B depicts a flowchart of a method by which an electronic device activates and de-activates a virtual background during a video communication session in response to detecting the presence of a new facial image in a background area of a live video feed, according to one or more embodiments.

### DETAILED DESCRIPTION

According to one or more aspects of the present disclosure, the illustrative embodiments provide an electronic device, a method, and a computer program product for activating and de-activating a virtual background during a video communication session in response to detecting the presence of a new facial image in a background area of a live video feed.

An electronic device with a camera can be used to conduct a video communication session with one or more other electronic devices. During a video communication session, a user can choose to turn on a virtual background that replaces the current video background with a pre-selected virtual background. A virtual background is an image or video that is imposed behind a video conference participant while they are in a video communication session. Virtual backgrounds are useful in situations where the video conference participant's environment is not ideal for video conferencing. Virtual backgrounds are often used as a default setting by a user during a video communication session.

There are occurrences, during a personal video communication session, when a family member may want to join in the video communication session. During a business video communication session, a co-worker may want to join the video communication session. Unfortunately, a video conference participant may not be aware of other persons entering into the background of the video conference that should be included in the video conference. The person entering remains obscured in the background, when the intent would be for the person entering to be visible to the video conference. Automating the removal of the virtual background on the detection of a known individual enables the user to not have to (i) see the person entering the space behind them or (ii) remember to turn off the virtual background to allow the person to be visible on the video conference.

The embodiments disclosed herein addresses and overcome the aforementioned problems of an electronic device being used in a video communication session. One or more aspects of the embodiments disclosed herein enable an electronic device to detect the presence of a new facial image in a background area of a live video feed. The new facial image is one that is not currently visible within the transmitted live video feed, in part because of the inclusion of a virtual background. The embodiments enable the electronic device to, in response to detecting the presence of the new facial image in the background field of view (FOV), determine if the new facial image contains a face of an approved on-screen video conference individual who can be presented on the live video feed. The embodiments further enable the electronic device to render and present a user selectable option on a display to de-activate the virtual background from the live video feed, in response to determining the new facial image contains the face of the approved on-screen video conference individual.

In a first embodiment, an electronic device includes a communications subsystem that enables the electronic device to communicatively connect with at least one second electronic device via an established video communication session. The electronic device includes one or more cameras, including a first camera that captures video and images from a first field of view (FOV), and at least one display including a first display. The electronic device includes a memory having stored thereon a communication module and a virtual background activation/de-activation (VBAD) module for activating and de-activating a virtual background during a video communication session. The electronic device includes at least one processor that is communicatively coupled to each of the communications subsystem, the one or more cameras, the at least one display, and the memory, and which executes program code of the communication module and the VBAD module. The at least one processor is configured to cause the electronic device to, while the electronic device is presenting, to a first video communication session, a first video feed comprising a first foreground image, captured by the first camera, that is superimposed onto a virtual background, monitor a field of view (FOV) of the one or more cameras to detect a presence of a new facial image in a first background area. The new facial image is one that is not currently visible within the first video feed because of inclusion of the virtual background. In response to detecting the presence of the new facial image, the at least one processor determines if the new facial image contains a face of at least one first approved on-screen video conference (AOVC) individual who can be presented on the transmitted first video feed within the first video communication session. In response to determining the new facial image contains the face of the at least one first AOVC individual, the at least one processor renders and presents a first user selectable option on the first display to de-activate the virtual background from the first video feed.

According to another embodiment, the method includes, while presenting, by an electronic device to a first video communication session, a first video feed comprising a first foreground image, captured by a first camera among one or more cameras, that is superimposed onto a virtual background, monitoring the field of view of the one or more cameras to detect a presence of a new facial image in a first background area. The new facial image is one that is not currently visible within the first video feed because of inclusion of the virtual background. In response to detecting the presence of the new facial image, the method includes determining if the new facial image contains a face of at least one first approved on-screen video conference (AOVC) individual who can be presented on the first video feed within the first video communication session. In response to determining the new facial image contains the face of the at least one first AOVC individual, the method includes rendering and presenting a first user selectable option on a first display to de-activate the virtual background from the first video feed.

According to an additional embodiment, a computer program product includes a non-transitory computer readable storage device having stored thereon program code that, when executed by at least one processor of an electronic device having a communications subsystem, one or more cameras including a first camera, and at least one display including a first display, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

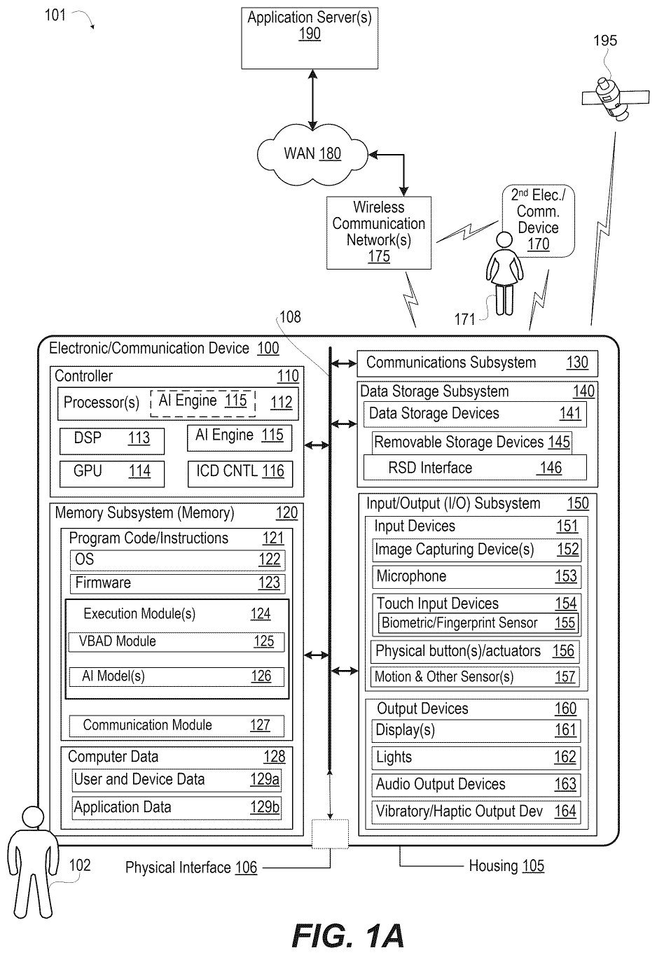

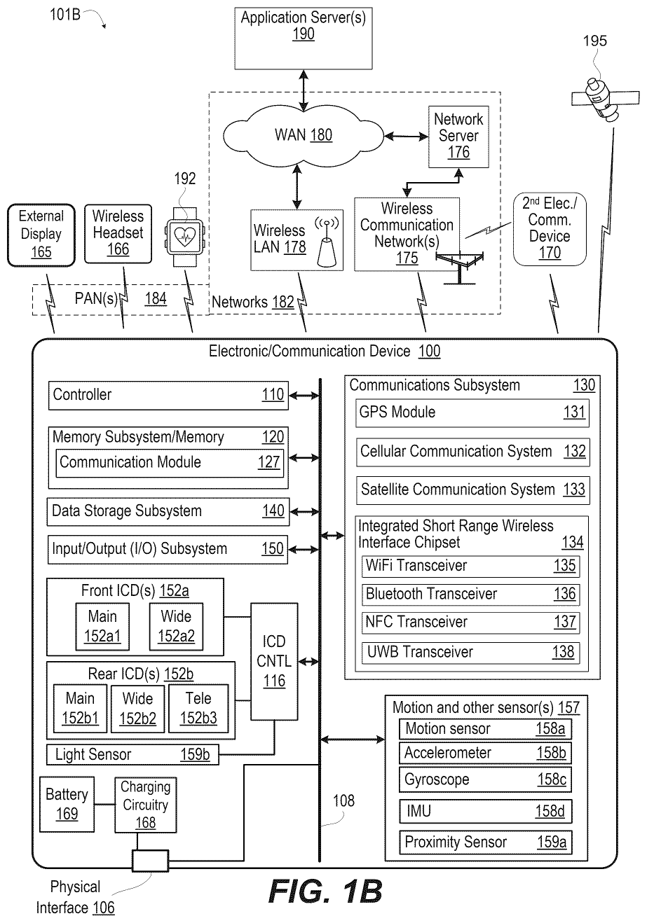

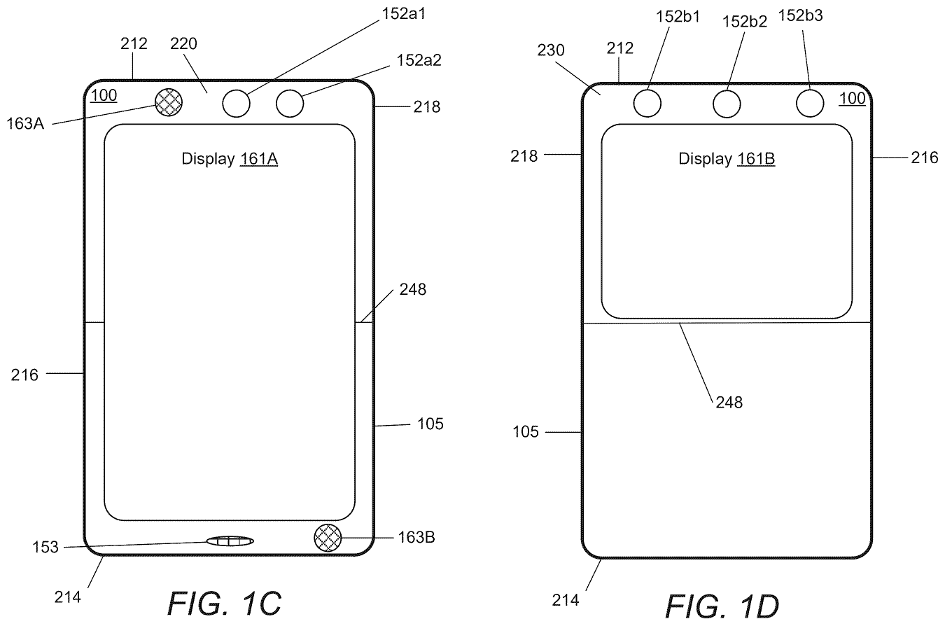

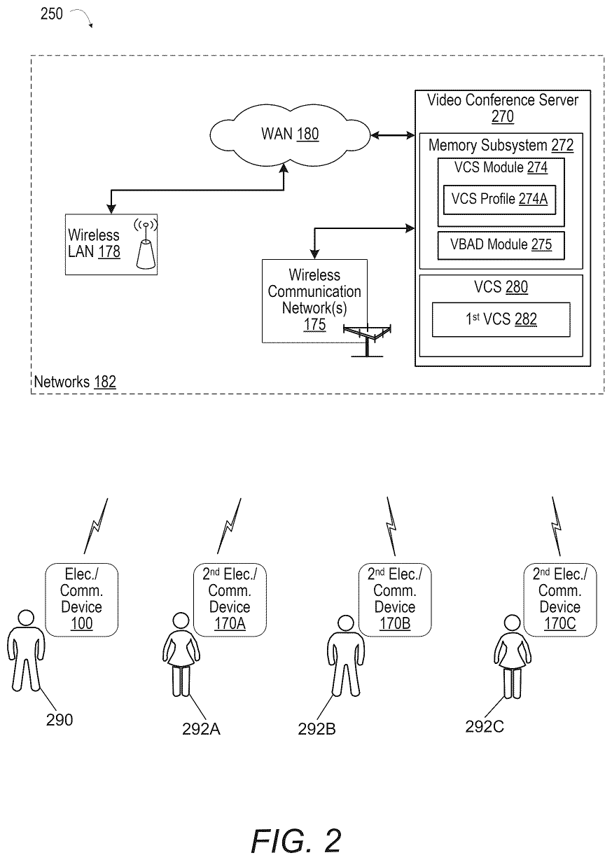

Those of ordinary skill in the art will appreciate that the hardware components and basic configuration depicted in the following figures may vary. For example, the illustrative components within electronic device 100 (FIGS. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in a communication environment 101 and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices having at least one camera (or image capturing device).

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown).

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) include instructions for an operating system (OS) 122, firmware 123, such as basic input/output system (BIOS) or Uniform Extensible Firmware Interface (UEFI). Program code 121 includes execution module(s) 124 that collectively provides the various features of the disclosure.

Execution module(s) 124 include, without limitation, virtual background activation/de-activation (VBAD) module 125. VBAD module 125 provides the features and operating functionality of the disclosed embodiments when the corresponding program instructions of VBAD module 125 are processed by/within processor 112/controller 110. Specifically, VBAD module 125 provides program instructions for activating and de-activating a virtual background during a video communication session in response to detecting the presence of a new facial image in a background area.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within VBAD module 125 and is trained to support the AI features of VBAD module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identify the underlying features performed by processing the different modules. For example, VBAD module 125 can include program instructions that cause or configure processor 112 to cause electronic device 100 to activate and de-activate a virtual background during a video communication session in response to detecting the presence of a new facial image in a background area of a live video feed. Other features provided by VBAD module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices. In one embodiment, communication module 127 enables electronic device 100 to establish and connect to a video communication session involving at least one second electronic device 170.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of VBAD module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, inertial measurement unit (IMU) 158d, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. IMU 158d measures force, angular rate, and orientation of electronic device 100, using a combination of accelerometers, gyroscopes, and magnetometers.

Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface 154 can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located or disposed on a rear surface of housing 105. Other embodiments provide for multiple integrated displays within electronic device 100 and references to display(s) 161 are assumed to refer to one or all of these multiple integrated displays.

Vibration/haptic output device 164 can cause electronic device 100 to vibrate or shake when activated. Vibration device 164 can be activated during an incoming call or message in order to provide an alert or notification to a user of electronic device 100. Audio output devices (e.g., a speaker) 163 can provide an audio alert or other audio output to a user. In one or more embodiments, integrated display 161, audio output devices (or speakers) 163, and vibration/haptic device 164 can generally and collectively be referred to as output devices.

With reference now to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone that is used by a second user 171, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of VBAD module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can also be used as a power supply port that is coupled to charging circuitry 168, which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 include front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera 152a1 and a wide-angle camera 152a2. Rear cameras 152b can include a main camera 152b1, a wide-angle camera 152b2, and a telephoto camera 152b3. Both sets of cameras 152 include image sensors that can capture images that are within the field of view (FOV) of each respective camera 152. In one or more embodiments, one or more of the cameras can be utilized to enable biometric authentication using facial image or iris scan recognition. In one embodiment, main camera 152a1 can be a high resolution camera that is used as a webcam during a video communication session.

In the description of each of the following figures, reference is also made to specific components illustrated within the preceding figure(s). Similar or same components are presented with the same leading reference number.

Turning to FIG. 1C, additional details of the front surface of electronic device 100 are shown. Electronic device 100 includes a housing 105 that contains the components of electronic device 100. Housing 105 includes a top side 212, bottom side 214, and opposed sides 216 and 218. Housing 105 further includes a front surface 220. Electronic device 100 includes a front display 161A embedded in front surface 220 of housing 105. In some implementations, microphone 153, front display 161A, front cameras 152a1, 152a2 and audio output devices 163A and 163B are at least partially integrated or disposed into front surface 220. In one embodiment, electronic device 100 can be a foldable electronic device that folds in half along a hinge 248.

Electronic device 100 includes a first audio output device 163A and second audio output device 163B. The first audio output device 163A is disposed or located towards top side 212 of housing 105. The second audio output device 163B is disposed or located towards bottom side 214 of housing 105. Each of the audio output devices 163A and 163B are communicatively coupled to processor 112.

With additional reference to FIG. 1D, additional details of the rear surface of housing 105 of electronic device 100 are shown. Electronic device 100 includes a rear display 161B embedded in rear surface 230 of housing 105. Various components of electronic device 100 are located or disposed on/at rear surface 230, including several rear cameras. In some implementations, rear display 161B, rear main camera 152b1, rear wide-angle camera 152b2, and rear telephoto camera 152b3 are at least partially integrated or disposed into rear surface 230. In one embodiment, electronic device 100 can fold in half along hinge 248. In the folded position, rear surface 230 becomes an outer surface of electronic device 100.

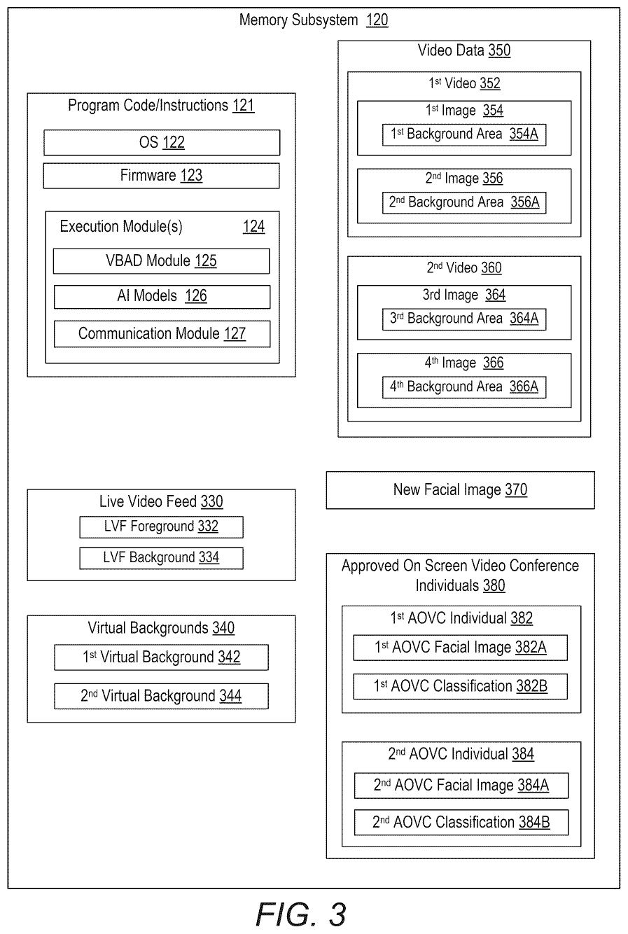

Referring to FIG. 2, a video communication session environment 250 is illustrated. Video communication session environment 250 enables one or more video communication sessions between electronic devices including electronic device 100, and several second electronic devices 170A, 170B, and 170C (170A-170C). Video communication session environment 250 includes a video conference server 270 that is communicatively connected to CWCN 175 and WAN 180 of networks 182.

Video conference server 270 includes a memory subsystem 272. Memory subsystem 272 includes a video conference session module 274, and VBAD module 275. Video conference session module 274 enables video conference server 270 to establish and connect and facilitate video communication sessions (VCS) 280 involving electronic device 100 and second electronic devices 170A-C. Video conference session module 274 includes one or more profile(s) 274A that are associated with the type of video communication session. In one example embodiment, profile(s) 274A can be a work profile that is associated with a business or place of employment. In another example embodiment, profile(s) 274A can be a personal/family profile that is associated with an individual's family or home. Video communication sessions 280 use audio and video for two-way or multi-way communication(s) between electronic device 100 and second electronic devices 170A-C. Video communication sessions 280 include a first video communication session 282.

VBAD module 275 can provide a similar functionally for video conference server 270 as VBAD module 125 enables for electronic device 100. VBAD module 275 provides program instructions for configuring electronic device 100 to perform the functions of activating and de-activating a virtual background during a video communication session in response to detecting the presence of a new facial image in a background area.

Video conference server 270 processes host-level functions for video communication sessions 280. Video communication sessions 280 are connected by video conference server 270 to each video communication session connected electronic device. Electronic device 100 captures a live video feed and transmits, via networks 182, the live video feed to video conference server 270. Video conference server 270 combines the videos received from multiple electronic devices and forwards the live video feeds to the second electronic devices. Electronic device 100 presents video received from video conference server 270 on a display (e.g., 161A or external display 165) for viewing by a local participant 290. Second electronic devices 170A-C present video received from video conference server 270 on a display for viewing by respective external or remote participants 292A, 292B, and 292C (292A-292C).

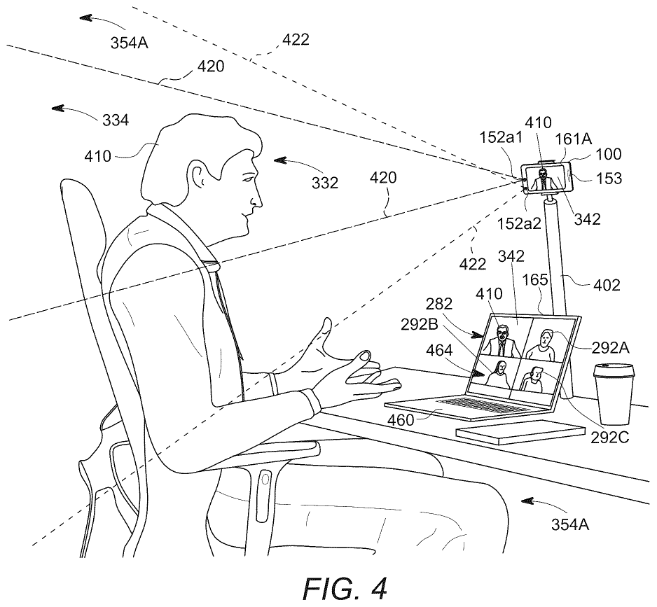

Referring to FIG. 3, there is shown one embodiment of example contents of memory subsystem 120 of electronic device 100. In the described embodiments, the contents of the memory are utilized to and/or configure electronic device 100 to complete the various processes described herein. Memory subsystem 120 includes program code/instructions 121 including data, software, and/or firmware modules, such as operating system (OS) 122, firmware 123, and execution module(s) 124. Execution module(s) 124 include VBAD module 125, AI models 126, and communication module 127.

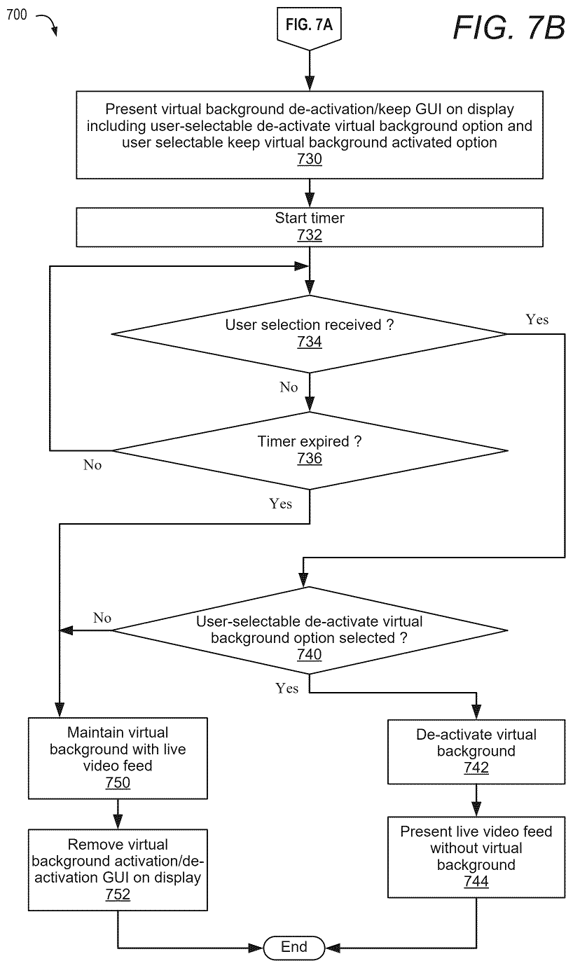

VBAD module 125 includes program code that is executed by processor 112 and configures processor 112 to enable/cause electronic device 100 to perform the various features of the present disclosure. In one or more embodiments, VBAD module 125 enables electronic device 100 to de-activate a virtual background during a video communication session in response to detecting the presence of a new facial image (of an approved participant/individual) in a background area of a FOV of the camera during a live video feed. In one or more embodiments, execution of VBAD module 125 by processor 112 configures electronic device 100 to perform the processes presented in the flowcharts of FIGS. 7A-7B as will be described below.

AI models 126 accelerate artificial intelligence, natural language processing (NLP), context evaluation (CE), and machine learning applications. Communication module 127 enables electronic device 100 to communicate and exchange data with other devices via networks 182.

Memory subsystem 120 includes live video feed 330. Live video feed 330 can be captured by front main camera 152a1 of electronic device 100 in real time and be presented to one or more video communication sessions 280. Live video feed 330 can include a live video feed (LVF) foreground 332 and a LVF background 334 that is captured within a field of view (FOV) by front main camera 152a1.

Memory subsystem 120 includes virtual backgrounds 340. Virtual backgrounds 340 are images or video that can be imposed behind a video communication session participant while the video communication session participant is in a video communication session. Virtual backgrounds 340 can be a simulated digital environment that replaces the real background of live video feed 330. The virtual background hides people or things in the background FOV (i.e., behind or on the side of) the video communication session participant. Virtual backgrounds 340 include first virtual background 342 and second virtual background 344.

Memory subsystem 120 includes video data 350. Video data 350 is video captured by front ultra-wide camera 152a2 of electronic device 100. Video data 350 includes first video 352 and second video 360. First video 352 includes a first frame or image 354 and second frame or image 356. First image 354 and second image 356 are examples of many still images that compose a complete moving video. First image 354 includes a first background area 354A and second image 356 includes a second background area 356A. First background area 354A is an area in the background of the first image 354 that is captured within a field of view by front ultra-wide camera 152a2. In one embodiment, front ultra-wide camera 152a2 captures, within a FOV that is wider than the FOV of front main camera 152a1, video and images that include the first background area 354A that is outside of or on a periphery of the LVF foreground 332 captured by the front main camera 152a1. Second background area 356A is an area in the background of the second image 356.

Second video 360 includes third image 364 and fourth image 366. Third image 364 includes a third background area 364A and fourth image 366 includes a fourth background area 366A.

Memory subsystem 120 includes new facial image 370. New facial image 370 is the facial image of a new individual that has entered into a background area (e.g., first background area 354A). In one embodiment, the new facial image 370 can pass through the periphery of the FOV into the first background area 354A, indicating a presence of an individual not currently presented within the live video feed. The new facial image 370 is not currently visible within the first video feed because of inclusion of one of the virtual backgrounds 340.

Memory subsystem 120 includes approved on-screen video conference (AOVC) individuals 380. AOVC individuals 380 are pre-determined individuals who can be presented on live video feed 330 within a video communication session. In one embodiment, a user of electronic device 100 can preselect the AOVC individuals 380 to be included in a live video feed. In an embodiment, a user of electronic device 100 can specify which AOVC individuals 380 are approved for inclusion in different types of video communication sessions. In one example embodiment, one individual (e.g., a coworker) can be approved for inclusion in a work video communication session and another individual (e.g., a family member) can be approved for inclusion in a family video communication session.

AOVC individuals 380 include first AOVC individual 382 and second AOVC individual 384. First AOVC individual 382 includes a first facial image 382A corresponding to the facial image of the first AOVC individual and first AOVC individual classification 382B. Second AOVC individual 384 includes a second facial image 384A corresponding to the facial image of the second AOVC individual and second AOVC individual classification 384B. First and second AOVC individual classifications identify video conference session types where the AOVC individuals would be allowed to participate. In an example embodiment, first AOVC individual classification 382B can be a person associated with work or an employer and second AOVC individual classification 384B can be a person associated with friends or family.

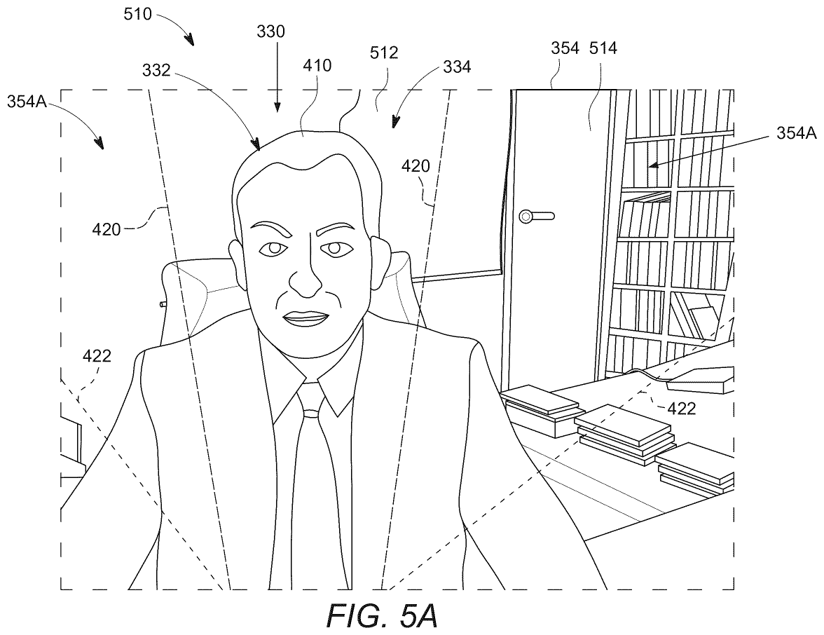

Referring to FIG. 4, electronic device 100 has been positioned to capture live video and audio of a local participant 410 during a first video communication session 282. Electronic device 100 is mounted to a stand 402 with display 161A and front cameras 152a1, 152a2 facing toward local participant 410. Front main camera 152a1 has a field of view (FOV) 420 that includes images and video of the local participant 410 including LVF foreground 332 and LVF background 334.

Front ultra-wide camera 152a2 has FOV 422 that is wider than the FOV 420 of front main camera 152a1. Front ultra-wide camera 152a2 has a FOV 422 that can capture images and video of areas that are outside of the FOV 420 captured by front main camera 152a1. Front ultra-wide camera 152a2 can capture images and video including first background area 354A. In one embodiment, the first background area 354A captured by front ultra-wide camera 152a2 is outside of or on a periphery of the LVF foreground 332 captured by the front main camera 152a1. Microphone 153 can capture audio input (i.e. speech) spoken by local participant 410 and can present the audio input to the first video communication session 282.

In some embodiments, the first video communication session 282 can be presented to the local participant 410 via an external display 165 that is communicatively connected to electronic device 100. In one embodiment, external display 165 can be the display of laptop computer 460. The first video communication session 282, shown on external display 165, can include several other remote participants 292A-292C that are shown in one or more sub-windows 464. At least one of sub-windows 464 can include the local participant 410. In FIG. 4, the local participant has selected a first virtual background 342 to replace the actual background (e.g., LVF background 334 and first background area 354A) as shown in the upper left window 464 of external display 165. The local participant is using the first virtual background 342 to hide the actual background during the video communication session.

In one embodiment, front main camera 152a1 can be a high-resolution camera that is used as a webcam during the first video communication session 282. Front main camera 152a1 can have an improved video quality as compared to a camera of laptop computer 460. In FIG. 4, during the first video communication session 282, the LVF foreground 332 and the first virtual background 342 are shown being presented to the video communication session on front display 161A.

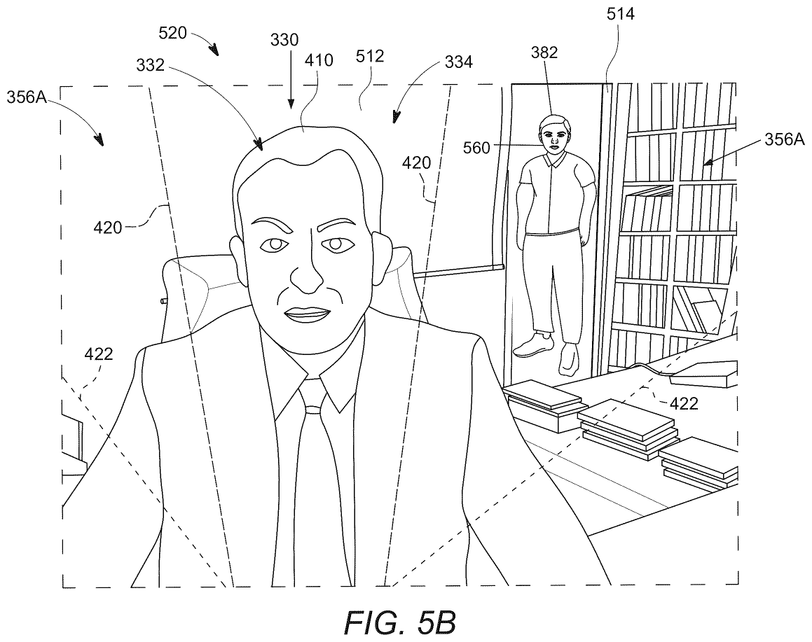

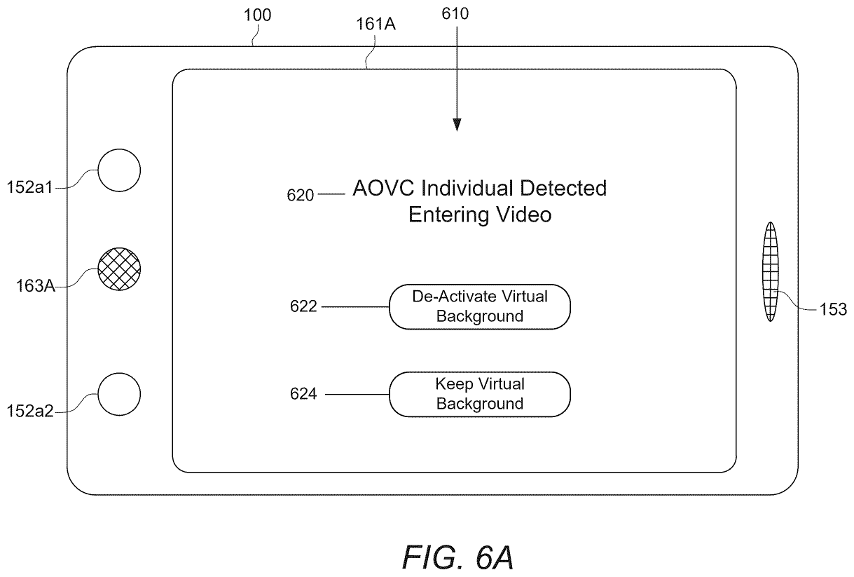

Turning to FIG. 5A, a first scene 510 is shown being captured by one or more cameras of electronic device 100. Scene 510 includes local participant 410 in a room 512 with a door 514 that would be captured and presented within live video feed 330 if live video feed 330 was transmitted without a virtual background. Front main camera 152a1 captures, within FOV 420, live video feed 330 including LVF foreground 332 and LVF background 334. Front ultra-wide camera 152a2 captures, within FOV 422, first image 354 that includes first background area 354A. First background area 354A is outside of or on a periphery of the LVF background 334. In one embodiment, during the video communication session, front ultra-wide camera 152a2 captures video data 350 comprising first video 352 with a first image 354 that includes the first background area 354A.

With reference to FIG. 5B, scene 520 is illustrated with first AOVC individual 382 entering room 512 through door 514 during the first video communication session 282. Scene 520 occurs at a later time after scene 510. Front ultra-wide camera 152a2 captures, within FOV 422, second image 356 that includes second background area 356A. In one embodiment, during the video communication session, front ultra-wide camera 152a2 captures video data 350 comprising first video 352 with a second image 356 that includes the second background area 356A.

Scene 520 of FIG. 5B is different than scene 510 of FIG. 5A in that first AOVC individual 382 has opened door 514 and entered into room 512, during the first video communication session 282. First AOVC individual 382 has been pre-approved by the local participant 410 to be included in the live video feed presented to a video communication session. First AOVC individual 382 has a face 560. Face 560 can correspond to the first AOVC facial image 382A. The first AOVC individual 382 entering room 512 causes a change to the second background area 356A from the first background area 354A. The second background area 356A is different than the first background area 354A.

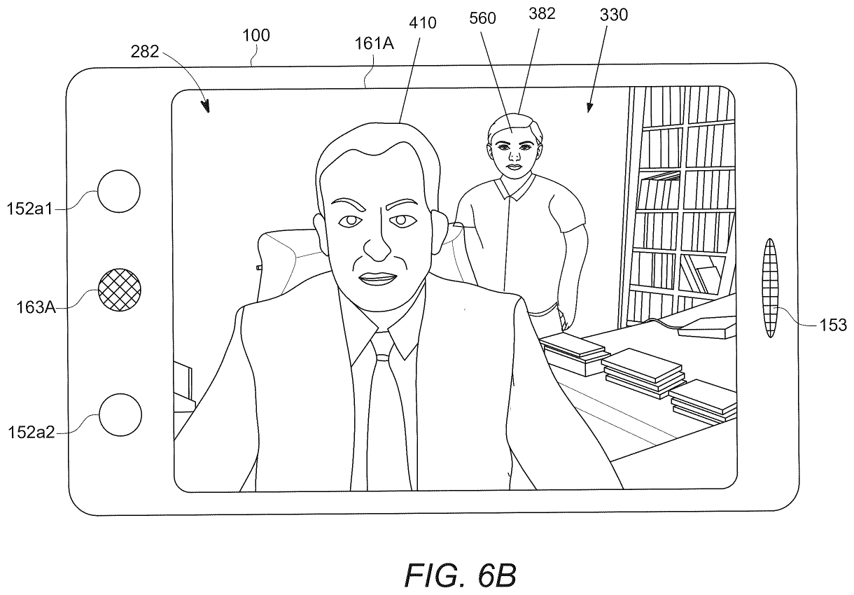

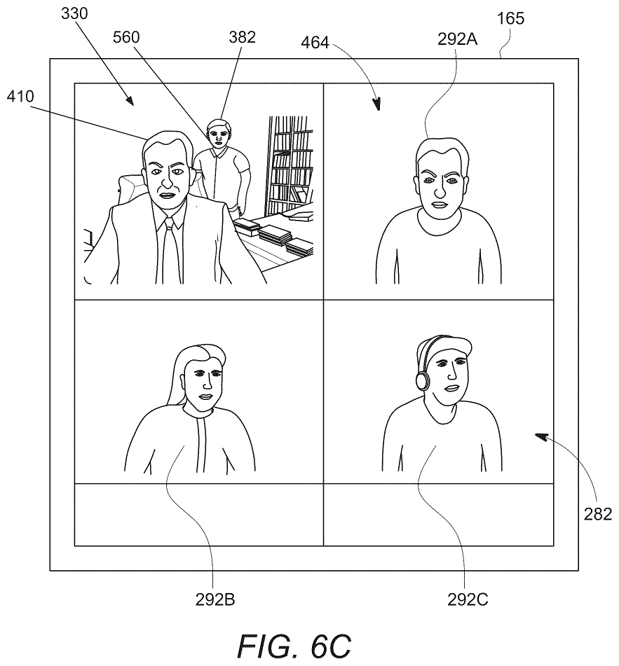

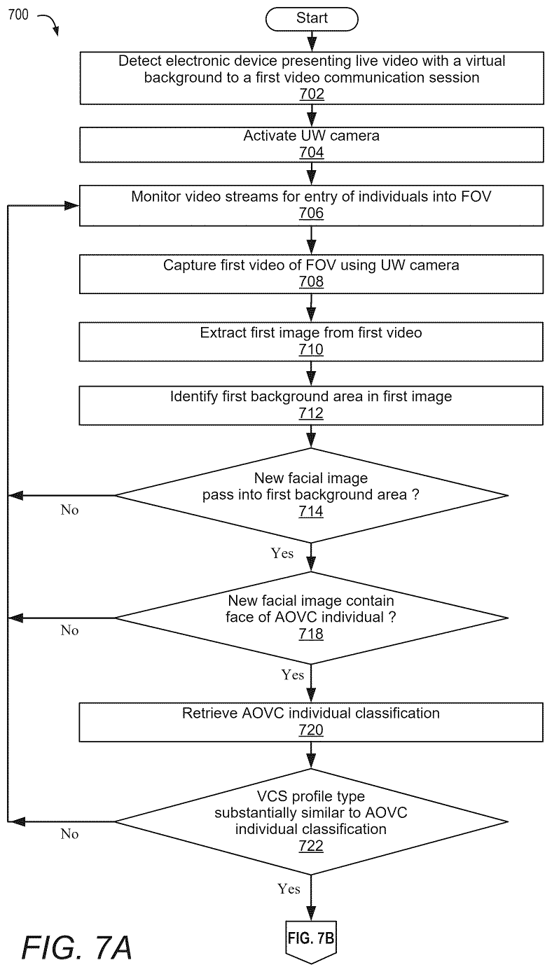

FIG. 6A illustrates an example virtual background de-activation/keep graphical user interface (GUI) 610 presented on display 161A of electronic device 100 after detecting the presence of a face (e.g., facial image 382A) associated with first AOVC individual 382 in a background area. The face of first AOVC individual 382 is not currently visible within the live video feed because of inclusion of the virtual background. In one embodiment, presentation of virtual background de-activation/keep GUI 610 is triggered by the detection of the face of an AOVC individual in a background area of video captured by ultra-wide-angle camera 152a2.

Virtual background de-activation/keep GUI 610 includes a notification 620 of the detection of the face of an AOVC individual in the background area entering or on the periphery of the background FOV of the one or more cameras capturing the live video feed 330. Virtual background de-activation/keep GUI 610 includes a user-selectable de-activate virtual background option 622 and a user-selectable keep virtual background option 624. The selection of de-activate virtual background option 622 causes the de-activation (i.e. removal) of the first virtual background 342 from the live video feed 330. The live video feed 330 is then presented to the first video communication session 282 without the first virtual background 342 allowing the AOVC individual to be presented within the live video feed 330 and thus viewed by the remote video conference participants 292A-292C. The selection of user-selectable keep virtual background option 624 maintains the first virtual background 342 with the live video feed 330. The user selectable options 622, 624 are removed following expiration of a time-out period for user selection.

Referring to FIG. 6B, electronic device 100 is shown presenting live video feed 330 on front display 161A without a virtual background to the first video communication session 282. In response to the detection of a face that matches a reference facial image (e.g., first facial image 382A) that is associated with first AOVC individual 382, electronic device 100 presents de-activation/keep GUI 610 on display 161A. Electronic device 100 uses facial recognition to match a human face detected within an image (e.g., second image 356) against a database of faces (i.e., AOVC individuals 380). Facial recognition uses facial features from a captured image to identify/determine if the face is that of a known individual. In one embodiment, cameras 152 of electronic device 100 can be artificial intelligence smart cameras that can perform facial recognition.

In response to user selection of de-activate virtual background option 622, electronic device 100 de-activates the first virtual background 342 from the live video feed 330. The live video feed 330 is presented to the first video communication session 282 without the first virtual background 342, allowing the first AOVC individual 382 to be visible within the background of the live video feed 330 and viewed by the remote video conference participants 292A-292C.

With reference to FIG. 6C, external display 165 of laptop computer 460 is shown presenting the live video feed 330 without a virtual background to the first video communication session 282. The first video communication session 282 includes the local participant 410 and the other remote participants 292A-292C. When a face 560 is detected adjacent to or on the periphery of LVF background 334 that matches a reference facial image (e.g., first facial image 382A) associated with first AOVC individual 382, electronic device 100 presents de-activation/keep GUI 610 on display 161A. In response to selection of de-activate virtual background option 622, electronic device 100 de-activates the first virtual background 342 from the live video feed 330. The live video feed 330 is presented to the first video communication session 282 without the first virtual background 342, allowing the background including the first AOVC individual 382 in the background to be presented within the live video feed 330 which is viewed by the remote video conference participants 292A-292C.

According to one aspect of the disclosure, while electronic device 100 is presenting, to a first video communication session 282, a first live video feed 330 comprising a LVF foreground 332, captured by main front camera 152a1, that is superimposed onto a first virtual background 342, electronic device 100 monitors video streams/data 350 of a background FOV from one or more front ultra-wide cameras 152a2 to detect a presence of a new facial image 370 in a first background area 354A. In response to detecting the presence of the new facial image 370, electronic device 100 determines if the new facial image 370 contains a face 560 of at least one first approved on-screen video conference (AOVC) individual 382 who can be presented on the live video feed within the first video communication session 282. In response to determining the new facial image 370 contains the face 560 of the at least one first AOVC individual 382, electronic device 100 renders and presents a user selectable de-activate virtual background option 622 on display 161A to de-activate the virtual background 342 from the live video feed 330.

According to another aspect of the disclosure, in response to detecting selection of the user selectable de-activate virtual background option 622, electronic device 100 de-activates the virtual background 342 from the live video feed 330. Electronic device 100 presents, to the first video communication session 282, the live video feed 330 including the live background, without the virtual background 342.

According to an additional aspect of the disclosure, in response to not detecting selection of the user selectable activate/de-activate virtual background option 622, 624, electronic device 100 maintains the virtual background 342 with the live video feed 330 and removes the user selectable de-activate virtual background option 622, following expiration of a time-out period for user selection.

According to a further aspect of the disclosure, electronic device 100 determines if the new facial image 370 is substantially similar to a first AOVC individual facial image 382A. Electronic device 100 triggers the rendering and presenting of the user selectable de-activate/keep virtual background options 622, 624, in response to determining the new facial image 370 is substantially similar to the first AOVC individual facial image 382A. In response to determining the new facial image is not substantially similar to the first AOVC individual facial image, electronic device 100 maintains activation of the virtual background 342.

According to one more aspect of the disclosure, in response to determining the new facial image 370 is substantially similar to the first AOVC individual facial image 382A, electronic device 100 autonomously de-activates the virtual background 342 from the live video feed 330. Electronic device 100 presents the live video feed 330 without the virtual background 342 to the first video communication session 282.

According to yet another aspect of the disclosure, electronic device 100 captures a first video 352 using the front ultra-wide camera 152a2 and extracts an image (e.g. first image 354) from the first video 352. Electronic device 100 identifies the background area (e.g. first background area 354A) within the first image. Electronic device 100 detects if the new facial image 370 passes through the periphery of the FOV into the first background area 354A, indicating a presence of an individual not currently presented within the live video feed 330. In response to detecting the new facial image passing through the periphery of the FOV into the first background area, electronic device 100 triggers presentation of the user selectable de-activate virtual background option 622 on display 161A to de-activate the first virtual background 342 from the live video feed 330.

According to a further aspect of the disclosure, in response to detecting the electronic device presenting the live video feed 330 with a virtual background to the first video communication session 282, electronic device 100 activates the front ultra-wide camera 152a2 to monitor for entry of one or more individuals (e.g. individual 382) into the FOV 422 while the virtual background is activated.

According to one or more additional aspect(s) of the disclosure, the front main camera 152a1 is a normal angle FOV camera that captures video and images of the live video background area (i.e. LVF background 334) and the front ultra-wide camera 152a2 is an ultra-wide angle FOV camera that captures video and images of an area wider than but inclusive of the live video background area.

According to still another aspect of the disclosure, while the electronic device is presenting the live video feed 330 without the virtual background 342 to the first video communication session 282, electronic device 100 monitors, using front ultra-wide camera 152a2, for the face of the first AOVC individual 382 leaving or not being present in the FOV 422. In response to determining that the face of the first AOVC individual 382 is not present in the FOV 422, electronic device 100 re-activates the virtual background 342.

In one embodiment, a portion of the live video feed foreground of a local participant can be presented to a video communication session as a head bubble with a surrounding virtual background. The electronic device 100 can detect entry of an approved person into the periphery of the FOV, while the head bubble is activated. After detecting entry of the approved person into the periphery of the FOV, the electronic device can remove the virtual background from the head bubble and present the live video feed to the video communication session without the virtual background (i.e., without the head bubble).

FIGS. 7A-7B (FIG. 7) depicts a flow chart presenting method 700 by which electronic device 100 de-activates a virtual background during a video communication session in response to detecting the presence of a new facial image in a background FOV of one or more cameras capturing the background video. The description of method 700 will be described with reference to the components and examples of FIGS. 1-6C. The operations depicted in FIGS. 7A-7B can be performed by electronic device 100 or any suitable electronic device that includes the one or more functional components of electronic device 100 that provide/enable the described features. One or more of the processes of the methods described in FIGS. 7A-7B may be performed by processor 112 executing program code associated with VBAD module 125.

With specific reference to FIG. 7A, method 700 begins at the start block. At block 702, method 700 includes detecting that electronic device 100 is presenting, to a first video communication session 282, a live video feed 330 comprising LVF foreground 332, captured by main front camera 152a1, the LVF foreground 332 superimposed onto a first virtual background 342. Method 700 includes activating front ultra-wide camera 152a2 (block 704) and monitoring the background video streams for entry of one or more individuals (e.g. individual 382) into the FOV 422 while the virtual background is activated for the live video feed (block 706).

Method 700 includes capturing first video 352 of the FOV 422 using the front ultra-wide camera 152a2 (block 708) and extracting a first image 354 from the first video 352 (block 710). Method 700 includes identifying the first background area 354A within the first image 354 (block 712). Method 700 includes determining if a new facial image 370 passes through the periphery of the FOV into the first background area 354A, indicating a presence of an individual not currently presented within the live video feed 330 (decision block 714). In response to determining that no new facial image 370 has passed into the first background area 354A, method 700 returns to block 706 to continue monitoring video streams for entry of one or more individuals (e.g. individual 382) into the FOV 422 while the virtual background is activated.

In response to determining a new facial image 370 has passed through the periphery into the first background area 354A, method 700 includes determining if the new facial image 370 contains a face 560 of at least one first AOVC individual 382 who can be presented on the live video feed within the first video communication session 282 (decision block 718). Method 700 performs facial recognition of new facial image 370 to determine if the face in facial image 370 is that of a known individual. In response to determining the new facial image 370 does not contain a face 560 of at least one first AOVC individual 382, method 700 returns to block 706 to continue monitoring video streams for entry of one or more individuals. In response to determining the new facial image 370 does contain face 560 of at least one first AOVC individual 382, method 700 includes retrieving first AOVC individual classification 382B associated with the at least one first AOVC individual 382 (block 720).

Method 700 includes determining if the VCS profile 274A is substantially similar to the first AOVC individual classification 382B associated with the at least one first AOVC individual 382 (decision block 722). In response to determining the VCS profile 274A is not substantially similar to the first AOVC individual classification 382B associated with the at least one first AOVC individual 382, method 700 returns to block 706 to continue monitoring video streams for entry of one or more individuals.

Turning to FIG. 7B, in response to determining the VCS profile 274A is substantially similar to the first AOVC individual classification 382B associated with the at least one first AOVC individual 382, method 700 presents virtual background de-activation/keep GUI 610 on display 161A (block 730). Virtual background de-activation/keep GUI 610 includes user-selectable de-activate virtual background option 622 and user-selectable keep virtual background activated option 624.

In another embodiment, in response to determining the VCS profile 274A is substantially similar to the first AOVC individual classification 382B associated with the at least one first AOVC individual 382, method 700 autonomously de-activates the first virtual background 342 from the live video feed 330 and presents the live video feed 330 without the virtual background to the first video communication session 282.

Method 700 includes starting a timer (block 732) and determining if a user (i.e., local participant 410) has selected either of user-selectable de-activate virtual background option 622 or user-selectable keep virtual background activated option 624 (decision block 734). In response to determining the user has not made a selection, method 700 includes determining if the timer has expired (decision block 736). In response to determining the timer has not expired, method 700 returns to decision block 734 to continue determining a selection is detected or if the timer has expired.

In response to determining the user has made a selection (decision block 734), method 700 includes determining if the user has selected user-selectable de-activate virtual background option 622 (decision block 740). In response to determining the user has selected user-selectable de-activate virtual background option 622, method 700 includes de-activating the virtual background 342 from the live video feed 330 (block 742) and presenting, to the first video communication session 282, the live video feed 330 without the virtual background 342 (block 744). Method 700 terminates at the end block.

In response to determining the user has not selected user-selectable de-activate virtual background option 622, or detecting user selection of user-selectable keep virtual background activated option 624, or in response to determining the timer has expired, method 700 includes maintaining the virtual background 342 with the live video feed 330 (block 750) and removing the user selectable options 622, 624 for user selection (block 752). Method 700 ends at the end block.

The disclosure provides improvements in an electronic device being used in a video communication session by enabling the electronic device to detect a new facial image in a background area of a FOV that is replaced with a virtual background in the live video feed. Further, the disclosure enables the electronic device to render and present a user selectable option on a display to de-activate the virtual background from the live video feed, in response to determining the new facial image contains the face of an approved on-screen video conference individual.

The disclosure enables an ultra-wide camera to function as a detector to detect entry of an individual into a background area, such as the entry of a person into a room. Thus, the electronic device is able to detect background images even while the virtual background is activated in order to determine if the background image includes a person that should be presented in the live video feed. The electronic device thus automatically renders and presents a user selectable option on a display to de-activate the virtual background from the live video feed such that that detected person can be presented in the live video feed to the video communication session.

In the above-described methods of FIGS. 7A-7B, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a communications subsystem that enables the electronic device to communicatively connect with at least one second electronic device via an established communication session;
one or more cameras, including a first camera that captures video and images from a first field of view (FOV);
at least one display including a first display;
a memory having stored thereon a communication module and a virtual background activation/de-activation (VBAD) module for activating and de-activating a virtual background during a video communication session; and
at least one processor communicatively coupled to each of the communications subsystem, the one or more cameras, the at least one display, and the memory, and which executes program code of the communication module and the VBAD module, the at least one processor configured to cause the electronic device to:
while the electronic device is presenting, to a first video communication session, a first video feed comprising a first foreground image, captured by the first camera, that is superimposed onto a virtual background, monitor video streams from the one or more cameras to detect a presence of a new facial image in a first background area, the new facial image not currently visible within the first video feed because of inclusion of the virtual background;
in response to detecting the presence of the new facial image, determine if the new facial image contains a face of at least one first approved on-screen video conference (AOVC) individual who can be presented on the first video feed within the first video communication session; and
in response to determining the new facial image contains the face of the at least one first AOVC individual, render and present a first user selectable option on the first display to de-activate the virtual background from the first video feed.

2. The electronic device of claim 1, wherein the at least one processor is further configured to:
in response to detecting selection of the first user selectable option:
de-activate the virtual background from the first video feed; and
present, to the first video communication session, the first video feed without the virtual background.

3. The electronic device of claim 1, wherein the at least one processor is further configured to:
in response to not detecting selection of the first user selectable option:
maintain the virtual background with the first video feed; and
remove the first user selectable option following expiration of a time-out period for user selection.

4. The electronic device of claim 1, wherein the at least one processor is further configured to:
determine if the new facial image is substantially similar to a first AOVC individual facial image;
trigger the rendering and presenting of the first user selectable option, in response to determining the new facial image is substantially similar to the first AOVC individual facial image; and
in response to determining the new facial image is not substantially similar to the first AOVC individual facial image, maintain activation of the virtual background.

5. The electronic device of claim 4, wherein the at least one processor is further configured to:
in response to determining the new facial image is substantially similar to the first AOVC individual facial image:
autonomously de-activate the virtual background from the first video feed; and
present the first video feed without the virtual background to the first video communication session.

6. The electronic device of claim 1, further comprising:
a second camera having a second FOV that captures at least one portion of the first background area that is on a periphery of the first FOV; and
wherein to detect the presence of the new facial image, the at least one processor is further configured to:
capture a second video using the second camera;
extract a second image from the second video;
identify the first background area within the second image;
detect if the new facial image passes through the periphery into the first background area, indicating a presence of an individual not currently presented within the first video feed; and
in response to detecting the new facial image passes through the periphery into the first background area, trigger presentation of the first user selectable option on the first display to de-activate the virtual background from the first video feed.

7. The electronic device of claim 1, further comprising:
a second camera that captures video and images from a second FOV that incorporates at least one area outside of the first FOV, the second FOV being wider than the first FOV;
wherein the at least one processor is further configured to:
in response to detecting the electronic device presenting the first video feed to the first video communication session, activate the second camera to monitor for entry of one or more second individuals into the first FOV while the virtual background is activated.

8. The electronic device of claim 7, wherein the first camera is a normal angle FOV camera that captures video and images of the first background area and the second camera is an ultra-wide angle FOV camera that captures video and images of an area wider than but inclusive of the first background area.

9. A method comprising:
while presenting by an electronic device, to a first video communication session, a first video feed comprising a first foreground image, captured by one or more cameras including a first camera, that is superimposed onto a virtual background, monitoring, via at least one processor, video streams from the one or more cameras to detect a presence of a new facial image in a first background area, the new facial image not currently visible within the first video feed because of inclusion of the virtual background;
in response to detecting the presence of the new facial image, determining if the new facial image contains a face of at least one first approved on-screen video conference (AOVC) individual who can be presented on the first video feed within the first video communication session; and
in response to determining the new facial image contains the face of the at least one first AOVC individual, rendering and presenting a first user selectable option on a first display to de-activate the virtual background from the first video feed.

10. The method of claim 9, further comprising:
in response to detecting selection of the first user selectable option:
de-activating the virtual background from the first video feed; and
presenting, to the first video communication session, the first video feed without the virtual background.

11. The method of claim 9, further comprising:
in response to not detecting selection of the first user selectable option:
maintaining the virtual background with the first video feed; and
removing the first user selectable option following expiration of a time-out period for user selection.

12. The method of claim 9, further comprising:
retrieving a first AOVC individual facial image;
determining if the new facial image is substantially similar to the first AOVC individual facial image;
triggering the rendering and presenting of the first user selectable option, in response to determining the new facial image is substantially similar to the first AOVC individual facial image; and
in response to determining the new facial image is not substantially similar to the first AOVC individual facial image, maintaining activation of the virtual background.

13. The method of claim 12, further comprising:
in response to determining the new facial image is substantially similar to the first AOVC individual facial image:
autonomously de-activating the virtual background from the first video feed; and
presenting the first video feed without the virtual background to the first video communication session.

14. The method of claim 9, wherein detecting the presence of the new facial image comprises:
capturing a second video using a second camera, the second camera having a second field of view (FOV) that captures at least one portion of the first background area that is on a periphery of a first FOV captured by the first camera;
extracting a second image from the second video;
identifying the first background area within the second image;
detecting if the new facial image passes through the periphery into the first background area, indicating a presence of an individual not currently presented within the first video feed; and
in response to detecting the new facial image passes through the periphery into the first background area, triggering presentation of the first user selectable option on the first display to de-activate the virtual background from the first video feed.

15. The method of claim 14, further comprising:
in response to detecting the electronic device presenting the first video feed to the first video communication session, activating the second camera to monitor for entry of one or more second individuals into the first FOV while the virtual background is activated.

16. The method of claim 15, wherein the first camera is a normal angle FOV camera that captures video and images of the first background area and the second camera is an ultra-wide angle FOV camera that captures video and images of an area wider than but inclusive of the first background area.

17. A computer program product comprising:
a computer readable storage device having stored thereon program code which, when executed by at least one processor of an electronic device having a communications subsystem that enables the electronic device to communicatively connect with at least one second electronic device via an established communication session, one or more cameras, including a first camera that captures video and images from a first field of view (FOV), and at least one display including a first display, configures the electronic device to complete the functionality of:
while the electronic device is presenting, to a first video communication session, a first video feed comprising a first foreground image, captured by the first camera, that is superimposed onto a virtual background, monitoring video streams from the one or more cameras to detect a presence of a new facial image in a first background area, the new facial image not currently visible within the first video feed because of inclusion of the virtual background;
in response to detecting the presence of the new facial image, determining if the new facial image contains a face of at least one first approved on-screen video conference (AOVC) individual who can be presented on the first video feed within the first video communication session; and
in response to determining the new facial image contains the face of the at least one first AOVC individual, rendering and presenting a first user selectable option on the first display to de-activate the virtual background from the first video feed.

18. The computer program product of claim 17, wherein the program code further configures the electronic device to complete the functionality of:
in response to detecting selection of the first user selectable option:
de-activating the virtual background from the first video feed; and
presenting, to the first video communication session, the first video feed without the virtual background.

19. The computer program product of claim 17, wherein the program code further configures the electronic device to complete the functionality of:
in response to not detecting selection of the first user selectable option:
maintaining the virtual background with the first video feed; and
removing the first user selectable option following expiration of a time-out period for user selection.

20. The computer program product of claim 17, wherein the program code further configures the electronic device to complete the functionality of:
retrieving a first AOVC individual facial image;
determining if the new facial image is substantially similar to the first AOVC individual facial image;
triggering the rendering and presenting of the first user selectable option, in response to determining the new facial image is substantially similar to the first AOVC individual facial image; and
in response to determining the new facial image is substantially similar to the first AOVC individual facial image, maintaining activation of the virtual background.
